(19) United States
(12) Patent Application Publication
(10) Pub. No.: US 2026/0339768 A1
(43) Pub. Date: Oct. 29, 2026

(54) MULTI-MODAL REPORT CONTENT ANOMALY DETECTION

(71) Applicant: Microsoft Technology Licensing, LLC, Redmond, WA (US)

(72) Inventors: Ze LI, Shoreline, WA (US); Minghua MA, Bellevue, WA (US); Murali Mohan CHINTALAPATI, Redmond, WA (US); Chetan BANSAL, Seattle, WA (US); Madhura Prashant VAIDYA, Redmond, WA (US); Yuhan YAO, Cambridge, MA (US)

(21) Appl. No.: 19/191,320

(22) Filed: Apr. 28, 2025

(51) Int. Cl. G06F 11/07

(52) U.S. Cl. CPC G06F 11/079; G06F 11/0706

(57) ABSTRACT

A domain-specific agent may receive a multi-modal data signal associated with a reported performance issue and instructs a domain-specific multi-modal language model to identify a possible root cause for the reported performance issue. The domain-specific agent may retrieve, using the domain-specific agent, from a pre-populated hypothesis tree, a hypothesis that identifies the possible root cause and sets forth a series of operations for testing whether the possible root cause is linked to the reported performance issue. The domain-specific agent may instruct the domain-specific multi-modal language model to execute the series of operations for testing the hypothesis. In response to receiving an output from the domain-specific multi-modal language model identifying the hypothesis as true, the domain-specific agent generates and returns an output that identifies the possible root cause as a source of the reported performance issue.

### BACKGROUND

Organizations increasingly rely on complex, multi-modal reports (e.g., financial statements, operational dashboards) or ad hoc Structured Query Language (SQL) or Not Only SQL (NoSQL) queries to render graphs to monitor performance and inform decision-making. Such reports and graphs typically integrate heterogeneous modalities, such as tabular data, time-series trends, textual annotations, and graphical visualizations (e.g., bar charts, line graphs), to represent multi-indicator systems over time.

### SUMMARY

In some aspects, the techniques described herein relate to a computer-implemented method of investigating anomalies in multi-modal data signals, the computer-implemented method including: receiving, using a domain-specific agent, a multi-modal data signal associated with a reported performance issue; instructing, using the domain-specific agent, a domain-specific multi-modal language model to identify a possible root cause for the reported performance issue by comparing the multi-modal data signal to a historical anomaly dataset and identifying a historical similar multi-modal signal and a corresponding root cause for the historical similar multi-modal signal, the domain-specific multi-modal language model being trained on the historical anomaly dataset that includes historically-observed multi-modal data signals corresponding to reported performance issues and corresponding steps carried out to investigate the reported performance issues and further documenting root causes responsible for the reported performance issue; retrieving, using the domain-specific agent, from a pre-populated hypothesis tree, a hypothesis that identifies the possible root cause and sets forth a series of operations for testing whether the possible root cause is linked to the reported performance issue; instructing, using the domain-specific agent, the domain-specific multi-modal language model to execute the series of operations for testing the hypothesis; and in response to receiving an output from the domain-specific multi-modal language model identifying the hypothesis as true, generating and returning, using the domain-specific agent, an output that identifies the possible root cause as a source of the reported performance issue.

In some aspects, the techniques described herein relate to one or more tangible processor-readable storage media embodied with instructions for executing on one or more processors and circuits of a computing device a process for investigating anomalies in multi-modal data signals, the process including: receiving, using a domain-specific agent, a multi-modal data signal associated with a reported performance issue; instructing, using the domain-specific agent, a domain-specific multi-modal language model to identify a possible root cause for the reported performance issue by comparing the multi-modal data signal to a historical anomaly dataset and identifying a historical similar multi-modal signal and a corresponding root cause for the historical similar multi-modal signal, the domain-specific multi-modal language model being trained on the historical anomaly dataset that includes historically-observed multi-modal data signals corresponding to reported performance issues and corresponding steps carried out to investigate the reported performance issues and further documenting root causes responsible for the reported performance issue; retrieving, using the domain-specific agent, from a pre-populated hypothesis tree, a hypothesis that identifies the possible root cause and sets forth a series of operations for testing whether the possible root cause is linked to the reported performance issue; instructing, using the domain-specific agent, the domain-specific multi-modal language model to execute the series of operations for testing the hypothesis; and in response to receiving an output from the domain-specific multi-modal language model identifying the hypothesis as true, generating and returning, using the domain-specific agent, an output that identifies the possible root cause as a source of the reported performance issue.

In some aspects, the techniques described herein relate to a computing system for investigating features of interest in multi-modal data signals, the computing system including: one or more hardware processors; a domain-specific multi-modal language model stored in memory and trained on a domain-specific historical anomaly dataset corresponding to a knowledge domain including historically-observed multi-modal data signals including features of interest and corresponding steps carried out to investigate the features of interest and further documenting root causes responsible for the features of interest; and a domain-specific agent stored in the memory and executable by the one or more hardware processors and configured to: receive a multi-modal data signal including a feature of interest; instruct the domain-specific multi-modal language model to identify a candidate root cause for the feature of interest by comparing the multi-modal data signal to the domain-specific historical anomaly dataset and identify a historical similar multi-modal signal and a corresponding root cause for the historical similar multi-modal signal; retrieve, from a pre-populated hypothesis tree, a hypothesis corresponding to the candidate root cause, the hypothesis setting forth a series of operations for testing whether the candidate root cause is linked to the feature of interest; instruct the domain-specific multi-modal language model to execute the series of operations for testing the hypothesis; and in response to receiving an output from the domain-specific multi-modal language model identifying the hypothesis as true, generate and return an output that identifies the candidate root cause as a source of the feature of interest.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example computing environment in which an anomaly investigation system identifies root causes explaining one or more features of a multi-modal signal using a domain-specific multi-modal language model (MLM).

FIG. 2 illustrates an example computing environment in which an anomaly investigation system selects a domain-specific agent (e.g., domain-specific agent, domain-specific agent, . . . domain-specific agent) for an identified knowledge domain of a multi-modal signal and corresponding domain-specific tools (e.g., the domain-specific tools, the domain-specific tools, . . . the domain-specific tools) for the identified knowledge domain.

FIG. 3 illustrates an example computing environment in which an anomaly investigation system generates domain-specific tools that can be used by a domain-specific agent for determining root causes of features of a multi-modal signal corresponding to a knowledge domain.

FIG. 4 illustrates a computing environment in which a domain-specific agent determines candidate root causes for inferences identified in a multi-modal signal.

FIG. 5 illustrates a computing environment in which a domain-specific agent communicates with a domain-specific MLM to test hypotheses corresponding to candidate root causes for explaining a feature of interest in a multi-modal signal.

FIG. 6 illustrates example operations for investigating anomalies in multi-modal data signals.

FIG. 7 illustrates an example computing device for implementing the described technology.

### DETAILED DESCRIPTION

Enterprises employ various types of anomaly investigation systems to detect abnormalities in computing system configurations and network telemetry data. This data is often compiled in the form of multi-modal reports/graphs. As used herein, the term “multi-modal data” refers to data that comes from multiple different types (or modalities) of sources, each capturing information in a unique way. For example, multi-modal data may include one or more of charts, graphs, tables, text, images, or other multi-modal data.

Due to the recent emergence of multi-modal language models, multi-model language models are being considered for integration into anomaly detection systems that analyze multi-modal data signals. However, many anomaly detection systems aim to analyze multi-modal signal to “predict” root causes for issues that are reported or detected within the computer networks that capture those multi-modal signals. Unlike traditional language model tasks that entail processing a single signal to derive a single inference, root cause prediction uniquely depends upon the ability to correctly string together a chain of inferences, often with complex dependencies.

Often times, root cause investigation depends on multi-step reasoning. For example, determining that a news event caused a drop in stock price for a company may involve multiple inference steps, such as identifying the stock price drop, identifying a decline in revenue in the multi-modal signal, identifying current events within a predetermined time frame before the stock price drop from news articles, identifying a company document that links one of the current events to the decline in revenue, and so forth. Although existing deep learning models may provide a degree of analysis of root causes, conventional deep learning models are typically unable to reliably follow multiple-step logical inference chains. The traditional deep learning approach is to train a model to correlate signal characteristics with inferences such that the model can—once trained—process an input signal and output an inference. This approach is inadequate in scenarios where the inference sought depends on multiple independent inferencing steps.

In conventional systems, prompt length is often limited, along with the number of “tasks” in a single prompt, to reduce the likelihood of model hallucinations. For this reason, it is infeasible to provide a deep learning model with a long list of instruction “steps” that have complex dependencies, or steps that cannot be processed without storage and evaluation of intermediate data. It is therefore challenging to use a deep learning model to infer a root cause that cannot be understood without multiple steps that have complex dependencies and conditions (e.g., if A is true and B is true then hypothesis is false, but if A is true and B is false and C is true then the hypothesis is true).

The described technology introduces an anomaly investigation system that uses domain-specific agents that are trained for specific knowledge domains to perform domain-specific processes. Each domain-specific agent communicates with a domain-specific language model in a multi-step process to uncovering domain-applicable root causes derived from analysis of multi-modal input data.

In the context of anomaly data, the term “root cause” refers to the underlying reason or source that explains why an anomaly (i.e., unexpected or abnormal behavior) occurred in a system, dataset, or process. For example, a root cause may include an explanation for one or more correlations, patterns, or other data features within the multi-modal signal.

Discourse between the domain-specific agent and the corresponding domain-specific language model is guided by a pre-populated root cause hypothesis tree for the associated domain. The domain-specific root cause hypothesis trees include, for each root cause hypothesis of a set of root cause hypotheses, a set of inference instructions that the domain-specific agent uses to direct its communications with the language model and obtain information relevant to different types of investigations.

For example, guided by the hypothesis tree, the domain-specific agent of the disclosed technology may interface with a language model to obtain output data for investigating a hypothetical root cause for a current event causing a price drop in a company's stock detected in the multi-modal signal. The several inference steps may involve identifying a drop in revenue over the past month in the company's revenue history, investigating a news article to determine a current event occurring between two and three months ago, and determining from company documents a statement that links the current event to the revenue drop. Based on output data from the language model relevant to the several inference steps, the hypothetical root cause of the current event causing the stock price drop can be confirmed or disregarded. The domain-specific agent of the disclosed technology may investigate alternative or additional root causes hypotheses responsive to disregarding the initial root cause hypothesis.

In another example, guided by the hypothesis tree, the domain-specific agent of the disclosed technology may interface with a language model to obtain output data for investigating a hypothetical root cause for a CPU spike and error rate surge detected in a multi-modal signal. The several inference steps may involve identifying a correlation between the CPU spike and error rate surge, examining a context of the correlation to determine that a new application programming interface (API) was deployed just prior to the spike/surge, and cross-checking the correlation with domain knowledge do determine that CPU spikes along with error rate increases may indicate API failure. Based on output data from the language model relevant to the several inference steps, the hypothetical root cause of the API failure causing the CPU spike and error rate surge can be confirmed or disregarded. The domain-specific agent of the disclosed technology may investigate alternative or additional root causes hypotheses responsive to disregarding the initial root cause hypothesis.

Usage of the domain-specific agent of the disclosed technology, which communicates with a language model to obtain information relevant to inference steps defined in a hypothesis tree, may increase the accuracy of root cause analysis over traditional deep learning approaches that are unable to perform such multistep inferencing.

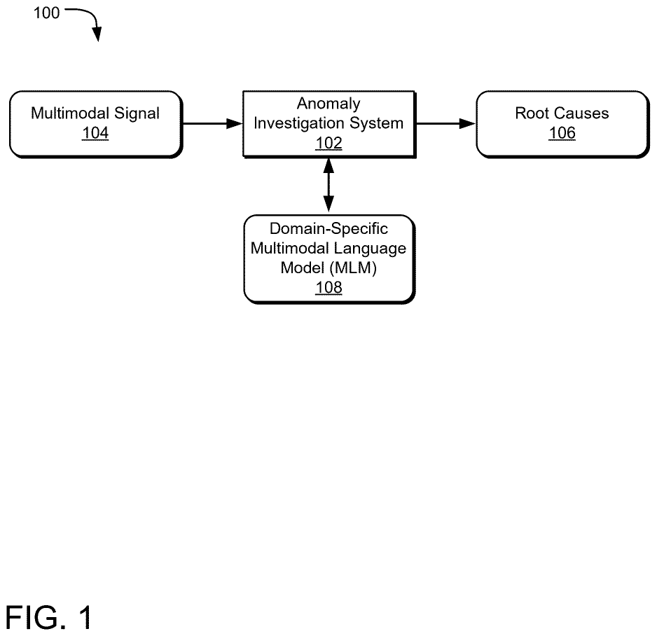

FIG. 1 illustrates an example computing environment 100 in which an anomaly investigation system 102 identifies root causes 106 explaining one or more features of a multi-modal signal 104 using a domain-specific multi-modal language model (MLM). The anomaly investigation system 102 may be a diagnostic system that determines root causes of features arising in the multi-modal signal 104 corresponding to a knowledge domain. In some cases, the features in the multi-modal signal 104 are linked to observed performance issues within a computing network. For example, a performance issue—such as high latency, high CPU usage, increased error rates, system time-out, etc.—is detected or reported and this triggers an anomaly analysis of multi-modal telemetry data collected during a timeframe corresponding to the performance issue. In this case, the multi-modal telemetry data pertains to device health and availability of networked devices.

In another implementation, the anomaly investigation system 102 is a medical diagnosis system that analyzes symptoms, test results, and images from a multi-modal medical profile to identify a disease that explains data features (e.g., an abnormal value in a blood test, etc.) of the medical profile. In another example, the anomaly investigation system 102 may be an equipment diagnostic system for industrial equipment (e.g., a wind turbine) that analyzes a multi-modal equipment status dashboard that includes sensor data, a log of operations, and video of the equipment and identifies a subcomponent of the equipment that explains data features (e.g., a detected abnormal vibration and abnormal temperature) of the equipment status dashboard. Further examples of an anomaly investigation system 102 include security systems, fraud detection systems, credit default prediction systems, earthquake detection systems, weather prognostication systems, or other systems that may analyze a multi-modal signal 104 and predict root causes of features detected in the multi-modal signal 104.

The multi-modal signal 104 includes data of one or more types (e.g., modes) of data. For example, the multi-modal signal 104 may include, but is not limited to, one or more of charts, graphs, logs, data lakes, code, scripts, files, transcripts, tables, time series, sensor data logs, computing device metrics, server metrics, network metrics, text, images, audio, video, location data, radar data, seismic data, point cloud data, LiDAR data, geographic maps, topographical maps, political maps, eye tracking data, depth maps, heat maps, global positioning system (GPS) and/or geolocation data, gyroscope data, biometric data, accelerometer data, augmented reality (AR) environment data, virtual reality (VR) environment data, mixed reality environment data, gaming environment data, social media statuses and comments, or other data types.

The anomaly investigation system 102 receives or otherwise accesses the multi-modal signal 104 from a dashboard service or other data aggregator that provides the component data of the multi-modal signal 104. For example, the multi-modal signal 104 may be obtained from a cloud resource provider that hosts virtual networks and that monitors telemetry in association with such networks including metrics such as CPU utilization, error rate, memory usage, latency, throughput, packet loss, bandwidth utilization, and more.

In another implementation, the multi-modal signal 104 is obtained from a patient's medical profile, which includes images, medical test data, doctors' notes, and other data types. The anomaly investigation system 102 may aggregate the multi-modal signal 104 from one or more data sources (e.g., sensors, cameras, servers, or other data sources that are communicatively coupled to the anomaly investigation system 102).

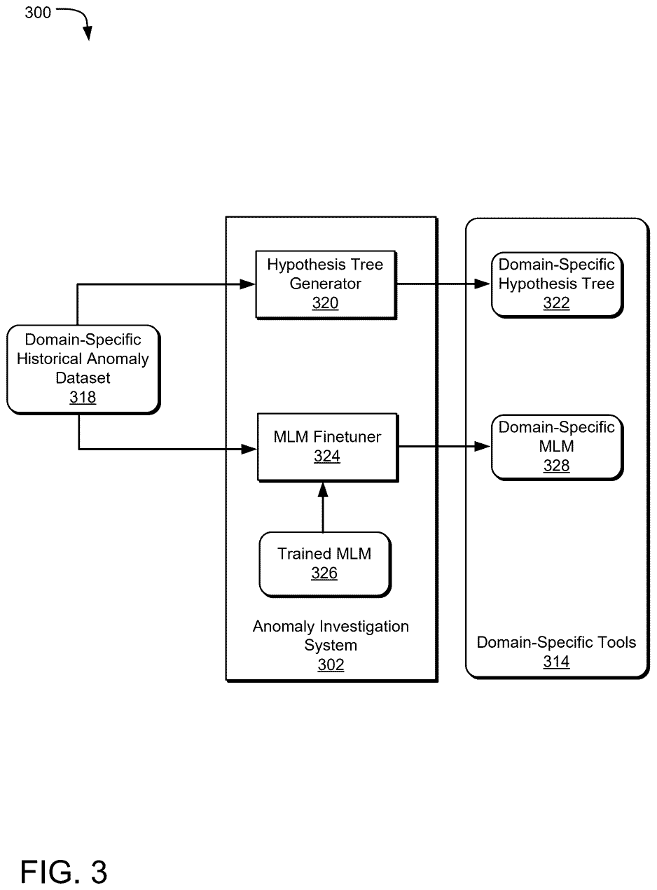

The anomaly investigation system 102 uses the domain-specific MLM 108 to obtain information for determining root causes 106 of one or more features of the multi-modal signal 104. The domain-specific MLM is an artificial intelligence (AI) language model that can process and reason over more than one type of data input. The domain-specific MLM may process these diverse inputs through shared or specialized neural pathways, allowing the domain-specific MLM to reason across modalities (e.g., describe an image, answer a question about a video, or generate captions from audio). The domain-specific MLM 108 is domain-specific because it is trained with knowledge-domain-specific training data to predict root causes 106 of features of the multi-modal signal 104 in a particular knowledge domain, e.g., a medical knowledge domain, a legal knowledge domain, a mechanical knowledge domain, a financial knowledge domain, or other knowledge domains. Examples of training the domain-specific MLM 108 for determining root causes 106 in multi-modal signals (e.g., the multi-modal signal 104) of a knowledge domain are described in the example implementations of FIG. 3.

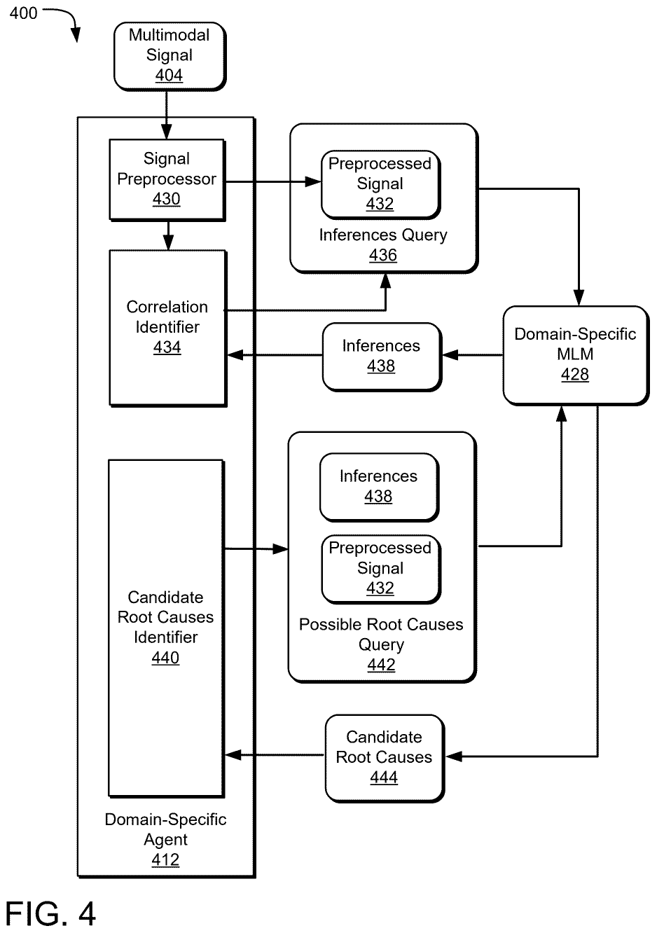

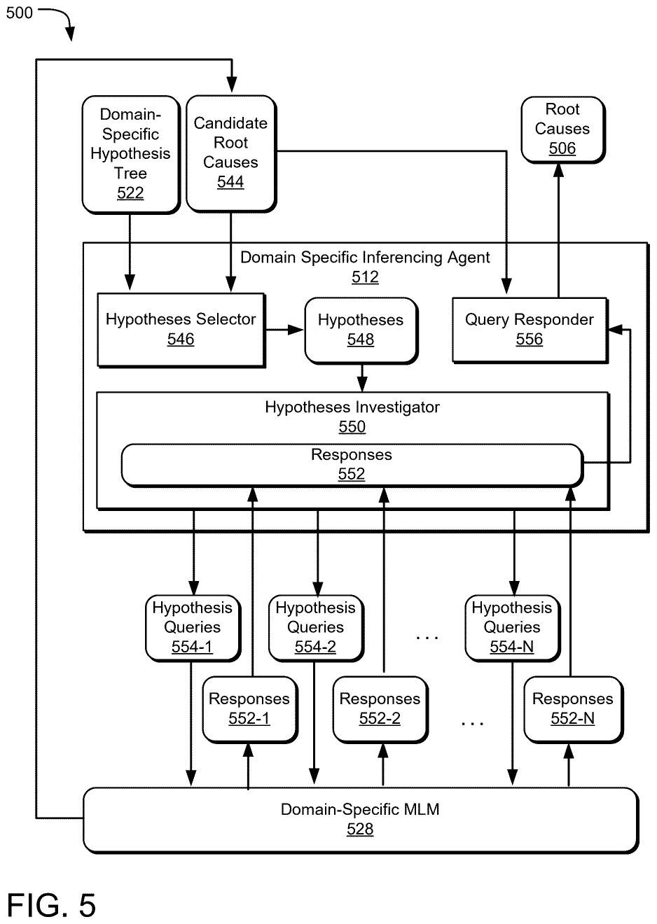

The anomaly investigation system 102 identifies root causes 106 for features of the multi-modal signal 104 based on information obtained from the domain-specific MLM 108. The features may include anomalous features (e.g., an object identified in a video along with a detected spike in a temperature sensor value) or other features of interest in the multi-modal signal 104. The root causes 106 may include, but are not limited to, identifications (e.g., diagnoses) of parts, processes, states, causes, or other root causes that explain the features of the multi-modal signal 104. The anomaly investigation system 102 may communicate the root causes 106 to a requesting system (e.g., a system that provided the multi-modal signal 104), to another system, to a user computing device (e.g., as an alert), or to another entity. Examples of the anomaly investigation system 102 identifying root causes 106 for features of the multi-modal signal 104 based on information obtained from the domain-specific MLM 108 are described in the example implementations of FIG. 4-5.

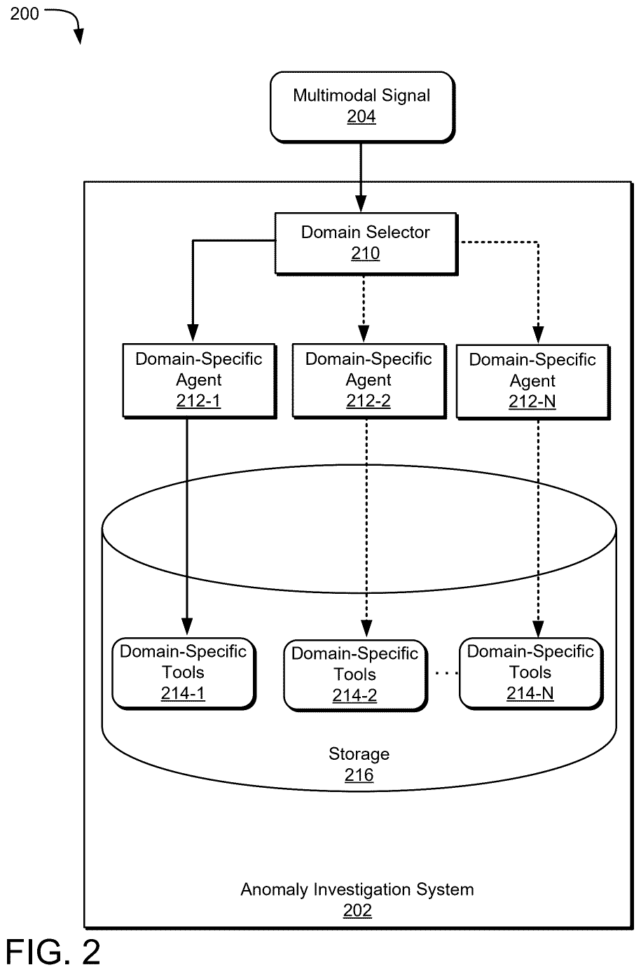

FIG. 2 illustrates an example computing environment 200 in which an anomaly investigation system 202 selects a domain-specific agent (e.g., domain-specific agent 212-1, domain-specific agent 212-2, . . . domain-specific agent 212-N) for an identified knowledge domain of a multi-modal signal 204 and corresponding domain-specific tools (e.g., the domain-specific tools 214-1, the domain-specific tools 214-2, . . . the domain-specific tools 214-N) for the identified knowledge domain. A domain-specific agent (e.g., the domain-specific agent 212-1) uses the corresponding domain-specific tools (e.g., the domain-specific tools 214-1) to analyze the multi-modal signal 204 and to determine root causes of features of the multi-modal signal 204. Domain-specific tools may be stored in a storage 216 accessible to the anomaly investigation system 202. Domain-specific tools may include a domain-specific hypothesis tree and a domain-specific MLM, the domain-specific hypothesis tree providing guidance to the domain-specific agent for obtaining information from the domain-specific MLM for investigating one or more root cause hypothesis for explaining a feature of the multi-modal signal 204. Examples of generating domain-specific tools for a knowledge domain, including training a domain-specific MLM and generating a domain-specific hypothesis tree, are described in the example implementations of FIG. 3. Examples of the anomaly investigation system 202 identifying root causes for features of the multi-modal signal 204 using a domain-specific agent (e.g., domain-specific agent 212-1) and corresponding domain-specific tools (e.g., domain-specific tools 214-1) are described in the example implementations of FIG. 4-5.

In the example shown, the anomaly investigation system 202 includes a domain selector 210. The domain selector 210 receives or otherwise accesses the multi-modal signal 204, identifies a knowledge domain corresponding to the multi-modal signal 204, and then selects a domain-specific agent and a corresponding set of domain-specific tools for the identified knowledge domain. For example, the domain-specific agent 212-1 and the domain-specific tools 214-1 may correspond to a financial markets knowledge domain, the domain-specific agent 212-2 and the domain-specific tools 214-2 may correspond to a medical knowledge domain, and the domain-specific agent 212-N and the domain-specific tools 214-N may correspond to a network security knowledge domain.

The domain selector 210 identifies a domain for the multi-modal signal 204. For example, the domain selector 210 detects stock abbreviations and a stock price chart in the multi-modal signal 204 and identifies a financial markets knowledge domain. In another example, the domain selector 210 identifies a client corresponding to the multi-modal signal 204 and selects a knowledge domain and a domain-specific agent (e.g., the domain-specific agent 212-1) corresponding to the client. The domain selector 210 selects the domain-specific agent 212-1 and the domain-specific tools 214-1 corresponding to the identified knowledge domain (e.g., financial markets) as indicated by solid arrows. For example, the domain selector 210 routs the multi-modal signal 204 to the domain-specific agent 212-1, which accesses the domain-specific tools 214-1. The domain selector 210 does not select either of the domain-specific agent 212-2 or domain-specific agent 212-N and the domain-specific tools 214-2 and domain-specific tools 214-N, nor rout the multi-modal signal 204 to these domain-specific agents and tools, as indicated by dashed arrows, because these correspond to other knowledge domains that are not identified from the multi-modal signal 204.

FIG. 3 illustrates an example computing environment 300 in which an anomaly investigation system 302 generates domain-specific tools 314 that a domain-specific agent may use for determining root causes of features of a multi-modal signal corresponding to a knowledge domain. The domain-specific tools 314 include a domain-specific MLM 328 and a domain-specific hypothesis tree 322 corresponding to a knowledge domain. The computing environment 300 includes an anomaly investigation system 302, which includes an MLM finetuner 324 and a hypothesis tree generator 320 which generate the domain-specific tools 314 based on a domain-specific historical anomaly dataset 318 corresponding to the knowledge domain.

The domain-specific historical anomaly dataset 318 is a dataset that includes historical data pertaining to previously investigated performance issues and resolved anomalies. Although the exact types of data stored for each past anomaly included in the domain-specific historical anomaly dataset may vary, this information may include data such as multi-modal signals (e.g., dashboard data) observed in association with past investigations pertaining to reported or detected network performance issues or other investigated anomalous events, labels indicating whether or not each past investigation let to positive identification of an actual anomaly, multi-modal signals (e.g., dashboard data), discussions of previous investigations of the multi-modal signals by experts (e.g., discussions that identify significant investigative steps and/or conclusions, such as conclusions identifying correlations between signal components that were positively linked to features of interest present in the multi-modal data signal or otherwise linked to observed performance issues), and root causes identified as being responsible for each investigated performance issue.

The MLM finetuner 324 finetunes a trained MLM 326 (e.g., a generic MLM) using the domain-specific historical anomaly dataset 318 to yield a domain-specific MLM 328. The trained MLM 326 is an AI model that can understand and generate language while simultaneously processing multiple types of input data, such as text, images, audio, video, or even structured data like tables or graphs. For example, the trained MLM 326 may be a Generative Pre-trained Transformer 4 (GPT-4) with Vision (GPT-4V) model, which is a GPT-4 model extension that can receive images as input alongside text and generate text-based responses based on both the images and text. Other types of MLM models may be used.

As discussed above, the domain-specific historical anomaly dataset 318 includes, for each of multiple previously conducted anomaly investigations, a multi-modal signal labeled with an anomaly classifier (e.g., a Y/N classifier whether or not the investigation led to the positive identification of an actual anomaly). Additionally, the domain-specific historical anomaly dataset 318 includes root causes for positively identified anomalies and discussion data that identifies significant investigative steps and/or conclusions for each of the prior investigations. In some implementations, an expert (e.g., an analyst or other professional) populates the domain-specific historical anomaly dataset 318 with the anomaly classifier labels and/or provides the discussion data from previously conducted anomaly investigations as reasoning steps in the domain-specific historical anomaly dataset 318 discussion data.

Before fine-tuning of the trained MLM 326, a hypothesis tree generator 320 is used to generate a domain-specific hypothesis tree 322. The domain-specific hypothesis tree 322 includes a set of root cause hypotheses and corresponding hypothesis testing methods for testing whether each root cause hypothesis of the set of root cause hypotheses is linked to a feature of interest (e.g., an anomaly, a performance issue, etc.) in a multi-modal signal of the knowledge domain. The hypothesis testing methods may specify input data (e.g., prompts, queries, etc.) to provide to the domain-specific MLM 328 to obtain information (e.g., outputs) from the domain-specific MLM 328 for verifying or rejecting the root cause hypothesis. The hypothesis testing methods may include a set of inference instructions for communicating with the domain-specific multi-modal language model to obtain relevant information from one or more components of the multi-modal data signal for testing each of the one or more candidate root causes including the possible root cause. The hypothesis testing methods may be sequential steps (e.g., a series of operations) that a domain-specific agent may follow to obtain information from the domain-specific MLM 328 for verifying the root cause hypothesis. For example, the sequential steps may include conditional steps and/or alternative steps (e.g., perform step A, and if step A obtains value X, then perform step B and if step B returns a value of Y, then the root cause hypothesis is accepted, but if either step A or step B obtains a value of Z then the root cause hypothesis is rejected). The domain-specific hypothesis tree 322 may represent the hypothesis testing methods as steps in a decision tree, a graph structure, or other data structure.

The domain-specific hypothesis tree 322 can either be generated by a human or by the trained MLM 326. For example, the domain-specific hypothesis tree 322 is generated by providing the trained MLM 326 with a set of inputs that includes anomaly data from the domain-specific historical anomaly dataset 318 and an instruction to use the anomaly data to generate various “root cause” hypothesis and steps that are executable to test each hypothesis. The anomaly data included in the set of inputs may include an entirety of the domain-specific historical anomaly dataset 318 or a subset thereof (e.g. if the dataset exceeds a cap on model input size). The instruction may include verbiage such as: “You are an expert in anomaly detection. Your task is to analyze historical incident reports and generate structured hypothesis test steps to analyze this multi-modal signal and determine whether a system is experiencing an anomaly. Here are some examples:
Hypothesis 1: Increased user traffic is causing server overload;
Test for Hypothesis 1: Check request volume trend over the past 24 hours.
Expected Result for Test that Verifies Hypothesis 1: If traffic is significantly higher than usual, this hypothesis is supported;
Action for supported Hypothesis 1: Analyze logs for unusual spikes and compare them with normal traffic patterns;
Hypothesis 2: A recent deployment introduced performance degradation; Test for Hypothesis 2: Identify if a new release was deployed before the anomaly;
Expected Result for Test that Verifies Hypothesis 2: If performance issues started immediately after deployment, this is likely the cause;
Action for Verified Hypothesis 2: Roll back to the previous version and monitor response times.”
The trained MLM 326 analyzes the input data according to the instruction and, in response, outputs a set of root cause hypotheses and corresponding hypothesis testing methods for testing each root cause hypothesis. The hypothesis tree generator 320 may populate the domain-specific hypothesis tree 322 with the set of root cause hypotheses and corresponding hypothesis testing methods that are output by the trained MLM 326.
In some implementations, an expert (e.g., an analyst) of the knowledge domain (e.g., a financial markets knowledge domain) generates the domain-specific hypothesis tree 322 (e.g., using the hypothesis tree generator 320 as a tool) and includes the domain-specific hypothesis tree 322 within the domain-specific tools 314 for the knowledge domain. Once generated, the hypothesis tree 322 is used as a data source (e.g., ground truth) during the below-described finetuning phase.

During a finetuning phase, the MLM finetuner 324 finetunes the trained MLM 326 to optimize the trained MLM 326 for two specific tasks—anomaly classification (e.g., does the multi-modal signal represent an anomaly?) and hypothesis testing (e.g., “is this particular root cause responsible for this anomaly? Provide your reasoning.”)

Training the model to perform the two tasks entails repeatedly providing the model with anomaly investigation data pertaining to different historical events captured in the domain-specific historical anomaly dataset 318 and asking the model (e.g., within a single input prompt) to perform two tasks with respect to each input. These two tasks include (1) anomaly classification; and (2) hypothesis testing and reasoning. For example, the trained MLM 326 is provided with the anomaly investigation data for a single event along with a prompt that instructs, “Determine whether this input signal includes an anomalous event. If you find that this input signal includes an anomalous event, determine whether [X Root Cause] is the reason. Provide your rationale.”

In this way, the MLM finetuner 324 iteratively finetunes the domain-specific MLM 328 to minimize a multi-task loss function that compares the Yes/No outputs to the feature labels in the domain-specific historical anomaly dataset 318 (e.g., task 1) and compares the output reasoning steps with the labeled reasoning steps in the domain-specific historical anomaly dataset 318 (e.g., task 2).

During this training process, weights are learned to enable to model to correctly perform both task #1 (the Y/N classification) and task #2 (testing the hypothesis & generating correct reasoning). During the finetuning phase, the ground truth answers for each task are known and passed into the model to compute weight adjustments following processing of each training sample. The “correct” ground truth anomaly classification (e.g., is_anomaly=Y/N) is included in the domain-specific historical anomaly dataset 318, along with the actual root cause determined for each previous anomaly investigation. The correct “reasoning” usable to test a hypothesis (e.g., root cause) is determined by cross-referencing the domain-specific hypothesis tree 322 to extract the “test” for the root cause (hypothesis) and the “expected result.”

The anomaly investigation system 302 may store the domain-specific tools 314 (including the domain-specific MLM 328 and the domain-specific hypothesis tree 322) in a storage accessible to a domain-specific agent corresponding to the knowledge domain.

FIG. 4 illustrates a computing environment 400 in which a domain-specific agent 412 determines candidate root causes for inferences 438 identified in a multi-modal signal 404. The computing environment 400 includes a domain-specific agent 412, which includes a signal preprocessor 430, a correlation identifier 434, and a candidate root causes identifier 440. The domain-specific agent 412 corresponds to a knowledge domain. The domain-specific agent 412 communicates with a domain-specific MLM 428, which is included in domain-specific tools corresponding to a knowledge domain.

The signal preprocessor 430 performs a set of preprocessing operations on the multi-modal signal 404 to yield a preprocessed signal 432. Preprocessing operations may include normalization, lowercasing, removing punctuation, stop word removal, tokenization, stemming, lemmatization, handling contractions, spelling correction, text compression, encoding, noise reduction, voice-to-text, frame extraction, color normalization, object detection, parsing, deduplication, null value imputation, normalization or standardization of numeric fields, encoding of categorical variables (like one-hot or label encoding), and transformation of timestamps into usable formats. The preprocessing operations clean, structure, normalize, or otherwise modify the multi-modal signal 404 (e.g., a raw multi-modal signal) into the preprocessed signal 432 so that important information from the multi-modal signal 404 can be represented in the preprocessed signal 432 and so that correlations between features may be discovered.

For example, a multi-modal signal 404 includes the following:
“‘metrics’:
{‘cpu_utilization’: [35, 40, 38, 90, 95],
‘error_rate’: [0.5, 0.6, 0.4, 5.0, 7.2],
‘memory_usage’: [60, 65, 63, 70, 68]},
‘incident_context’:
{‘recent_deployments’: [‘New API version deployed 10 min ago’],
‘user_reports’: [‘Multiple users experiencing timeouts’]}}”

In this example, the preprocessing steps may include: 1. identifying key metrics including CPU utilization, error rate, and memory usage; 2. recognizing trends (e.g., CPU jumped from ~40% to 95%, error rate increased significantly); and 3. normalizing the data of the multi-modal signal 404 by converting values into comparable scales for pattern recognition.

The correlation identifier 434 generates an inferences query 436 for the domain-specific MLM 428, including the preprocessed signal 432. The inferences query 436 instructs the domain-specific MLM 428 to identify relationships (e.g., correlations) between features of the multi-modal signal 404 and cross-check the relationships with domain knowledge to determine whether the relationships are likely to be linked with a feature of interest (e.g., an anomaly, a performance issue, a performance metric, or other feature of interest) identified in the preprocessed signal 432. For example, the correlation identifier 434 may 1. identify that CPU spike happens at the same time as an error rate surge; 2. examine an incident context to determine that a new API deployment happened just before the spike, and 3. cross-check the API deployment with domain knowledge that states that “CPU spikes alone are not anomalies, but correlated error rate increases may indicate failure.”

The domain-specific MLM 428 identifies, from the preprocessed signal 432 as an input, the inferences 438 as output and returns the inferences 438 to the correlation identifier 434 responsive to receiving the inferences query 436. For example, the inferences 438 may include a correlation among two or more features (e.g., among a stock price and revenue amount) identified in the preprocessed signal 432, where the correlation may be linked to a feature of interest (e.g., a drop in the stock price).

Correlations may include changes in features that occur within the same time frame, for example, a first correlation involves a stock price drop over the course of a 3-day time period while revenue decreases over the same 3-day time period, inferring that the revenue drop may have contributed to the stock price drop or may be caused by a prior cause that causes both the revenue drop and the stock price drop. In this example, a second correlation involves a news article published at the beginning of the 3-day time period corresponding to the fall in stock price, inferring that an event described in the news article may have affected the stock price decrease.

The candidate root causes identifier 440 transmits a possible root causes query 442 to the domain-specific MLM 428, the possible root causes query 442 including the inferences 438 and the preprocessed signal 432. The domain-specific MLM 428 receives possible root causes query 442 as an input and compares the inferences 438 and the preprocessed signal 432 to historical signals in the knowledge domain (e.g., upon which the domain-specific MLM 428 is finetuned) to identify candidate root causes 444 to explain the feature of interest of the multi-modal signal 404. In an example, the candidate root causes 444 that explain a CPU spike and a correlated error rate include “Hypothesis 1: A routine workload increased? and Hypothesis 2: An API bug caused excessive resource usage?.”

In another example, the feature of interest in the multi-modal signal 404 is a stock price drop (inferred from inferences 438 including a relationship between a declining stock price and a declining revenue amount) and the candidate root causes 444 including occurrence of news events and publishing of company announcements. For example, the candidate root causes 444 may explain the inferences 438 (e.g., the decline in revenue related to the decline in stock price), which is correlated to the feature of interest (e.g., stock price drop).

FIG. 5 illustrates a computing environment 500 in which a domain-specific agent 512 communicates with a domain-specific MLM 528 to test hypotheses corresponding to candidate root causes 544 for explaining a feature of interest in a multi-modal signal. The computing environment 500 includes a domain-specific agent 512, which includes a hypotheses selector 546, a hypotheses investigator 550, and a query responder 556. The domain-specific agent 512 corresponds to a knowledge domain. The domain-specific agent 512 employs domain-specific tools corresponding to the knowledge domain, including a domain-specific MLM 528 and a domain-specific hypothesis tree 522.

The hypotheses selector 546 receives candidate root causes 544 from the domain-specific MLM 528, for example, responsive to providing a possible root causes query to the domain-specific MLM 528 that includes a preprocessed signal generated from the multi-modal signal and inferences detected by the domain-specific MLM 528. The domain-specific agent 512 may determine a knowledge domain (e.g., financial markets knowledge domain) corresponding to the multi-modal signal and access domain-specific tools corresponding to the knowledge domain from a storage accessible to the domain-specific agent 512.

The hypotheses selector 546 selects the hypotheses 548 from the domain-specific hypothesis tree 522 corresponding to the candidate root causes 544. For example, the hypotheses 548 are a subset of available hypotheses in the domain-specific hypothesis tree 522 that identify the candidate root causes 544. The hypotheses 548 include hypothesis testing methods for testing whether each of the candidate root causes 544 is linked to a feature of interest in the multi-modal signal. The hypothesis testing methods may specify input data (e.g., hypothesis queries 554-1, hypothesis queries 554-2 . . . hypothesis queries 554-N.) to provide to the domain-specific MLM 528 to obtain responses 552 (e.g., responses 552-1, responses 552-2, . . . responses 552-N) from the domain-specific MLM 528 for verifying or rejecting the candidate root causes 544.

The hypotheses investigator 550 communicates with the domain-specific MLM 528 in accordance with hypothesis testing methods specified in each of the hypotheses 548 selected from the domain-specific hypothesis tree 522. In some scenarios, the hypotheses investigator 550 tests each of the hypotheses 548 sequentially until it obtains responses 552 that indicate a verified hypothesis that explains the candidate root causes 544 and then does not test the remaining hypotheses. In some scenarios, the domain-specific hypothesis tree 522 specifies conditions within the sequential order for testing hypotheses (e.g., test hypothesis A, then B, then test C if A and B are true, but test D instead of C if one of A or B is not true) and the hypotheses 548 selected from the tree are tested in the specified sequential order, including any specified conditions. For example, in a set of five hypotheses, if the hypotheses investigator 550 rejects hypothesis 1 and hypothesis 2 and then verifies hypothesis 3, the hypotheses investigator 550 does not test hypothesis 4 and hypothesis 5. In some scenarios, the hypotheses investigator 550 tests all of the hypotheses 548 selected from the domain-specific hypothesis tree 522 for testing the candidate root causes 544.

To test a hypothesis, the hypotheses investigator 550 transmits hypothesis queries (e.g., hypothesis queries 554-1, hypothesis queries 554-2, . . . hypothesis queries 554-N) corresponding to one or more of the hypotheses 548 (e.g., N hypotheses) and receives responses 552 (e.g., responses 552-1, responses 552-2, . . . responses 552-N) responsive to the hypothesis queries from the domain-specific MLM 528. The hypothesis queries may be specified in the hypothesis testing methods of each of the hypotheses 548. For example, to test the first hypothesis of a set of N hypotheses, the hypotheses investigator transmits hypothesis queries 554-1 to the domain-specific MLM 528 and receives responses 552-1 from the domain-specific MLM 528 generated as output data based on the hypothesis queries 554-1 as input data. The hypothesis queries 554-1 and the responses 552-1 received from the domain-specific MLM 528 responsive to the hypothesis queries 554-1 may be a series of successive queries/responses or may be a combined set of queries with a corresponding combined set of responses.

The hypothesis queries (e.g., hypothesis queries 554-1, hypothesis queries 554-2, . . . hypothesis queries 554-N) may include inferences (e.g., inferences 438) previously identified by the domain-specific MLM 528 and the preprocessed signal (e.g., preprocessed signal 432) that was generated from the original multi-modal signal (e.g., multi-modal signal 404). The responses 552 indicate which of the hypotheses 548 are accepted and which are rejected. The domain-specific hypothesis tree 522 may specify whether to accept or reject a candidate root cause based on which of (or which combination of) the hypotheses 548 is verified and/or rejected.

In an example, the feature of interest is a failure in a computing resource during a particular time period identified in the multi-modal signal, a first candidate root cause is “routine workload increase.” To test the first candidate root cause, the hypotheses investigator 550 transmits hypothesis queries 554-1 that queries the domain-specific MLM 528 asking if the error rate spiked during the particular time period. The responses 552-2 from the domain-specific MLM indicates that the error rate spiked, which corresponds to a rejection of the hypothesis. A second candidate root cause is an “API bug causing excessive resource usage.” To test the second candidate root cause, the hypotheses investigator 550 transmits hypothesis queries 554-2 that queries the domain-specific MLM 528 asking if the error rate spiked and if workload was deployed during the particular time period. The responses 552-2 from the domain-specific MLM indicates that the error rate did spike and the workload was deployed, which corresponds to a verification of (e.g., acceptance of) the hypothesis and confirmation of the second candidate root cause.

The query responder 556, returns root causes 506 of the candidate root causes 544 that are verified based on the responses 552 received from the domain-specific MLM 528. For example, one or more of the candidate root causes 544 may be verified (e.g., accepted) based on the responses 552 from testing of each of the hypotheses 548 corresponding to the candidate root causes 544. One or more of the candidate root causes 544 may be rejected based on the responses 552. For example, the root causes 506 include a text that states ““Hypothesis 1: A routine workload increased? False, because error rate also spiked and Hypothesis 2: An API bug caused excessive resource usage? True because this hypothesis is supported by deployment timing and rising error rates.” In some instances, the query responder 556 outputs an identity of the feature(s) of interest in the multi-modal signal, a description of the root causes 506 of the feature(s) of interest and may output a confidence score for the root causes 506. The root causes 506 may be integrated into (e.g., incorporated into) the original multi-modal signal. The root causes 506 may be transmitted to a requesting entity (e.g., a user computing device, another system, etc.) responsive to a query for root causes that includes the multi-modal signal.

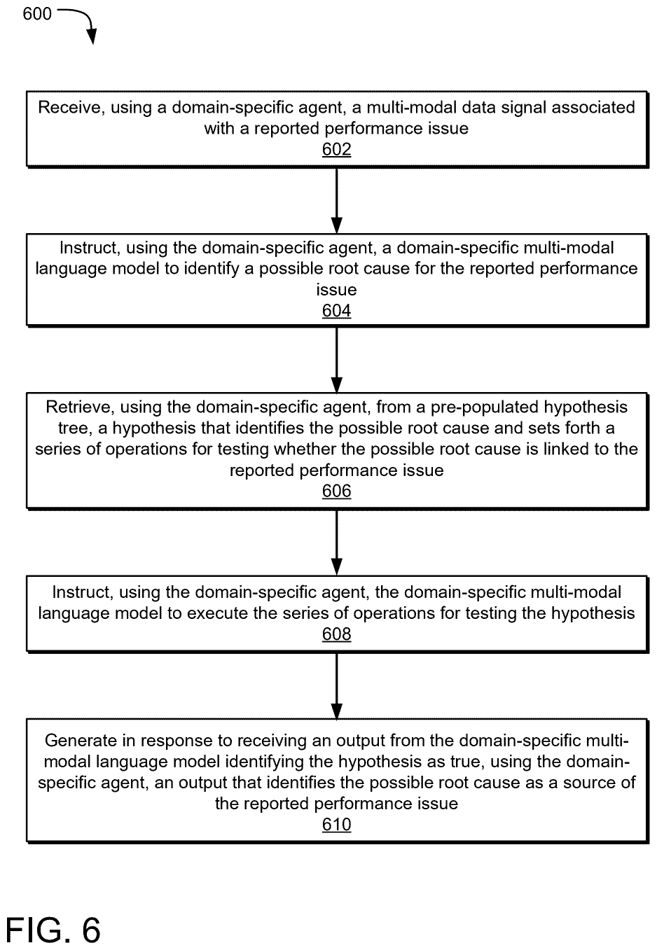

FIG. 6 illustrates example operations 600 for investigating anomalies in multi-modal data signals.

A receiving operation 602 receives, using a domain-specific agent, a multi-modal data signal associated with a reported performance issue. In some implementations, a knowledge domain for the multi-modal data signal is determined, the identified knowledge domain being a knowledge domain corresponding to the domain-specific agent, and the multi-modal data signal is transmitted to the domain-specific agent responsive to identifying the knowledge domain. In some implementations, one or more component features of a raw multi-modal data signal are normalized to yield the multi-modal data signal.

An instructing operation 604 instructs, using the domain-specific agent, a domain-specific multi-modal language model to identify a possible root cause for the reported performance issue. Identifying the possible root cause includes comparing the multi-modal data signal to a historical anomaly dataset and identifying a historical similar multi-modal signal and a corresponding root cause for the historical similar multi-modal signal. The domain-specific multi-modal language model is trained on the historical anomaly dataset that includes historically-observed multi-modal data signals corresponding to reported performance issues and corresponding steps carried out to investigate the reported performance issues, the historical anomaly dataset further documenting root causes responsible for the reported performance issue. In some implementations, the historical anomaly dataset includes analyses of the historically-observed multi-modal data signals, the analyses including reasoning steps for verifying the possible root cause.

A retrieving operation 606 retrieves, using the domain-specific agent, from a pre-populated hypothesis tree, a hypothesis that identifies the possible root cause and sets forth a series of operations for testing whether the possible root cause is linked to the reported performance issue. In some implementations, the pre-populated hypothesis tree includes one or more candidate root causes, a set of inference instructions for communicating with the domain-specific multi-modal language model to obtain relevant information from one or more components of the multi-modal data signal for testing each of the one or more candidate root causes including the possible root cause. In some implementations, a plurality of pre-populated hypothesis trees corresponding to each of a plurality of root causes including the possible root cause, is generated based on the historical anomaly dataset. In some implementations, the pre-populated hypothesis tree is generated based on the historical anomaly dataset, wherein generating the pre-populated hypothesis tree includes extracting annotated sets of inference instructions corresponding to the possible root cause from the historical anomaly dataset.

An instructing operation 608 instructs, using the domain-specific agent, the domain-specific multi-modal language model to execute the series of operations for testing the hypothesis.

A generating operation 610 generates, in response to receiving an output from the domain-specific multi-modal language model identifying the hypothesis as true, using the domain-specific agent, an output that identifies the possible root cause as a source of the reported performance issue. The domain-specific agent may return the output (e.g., to an entity from which the multi-modal signal was received) in response to receiving the output.

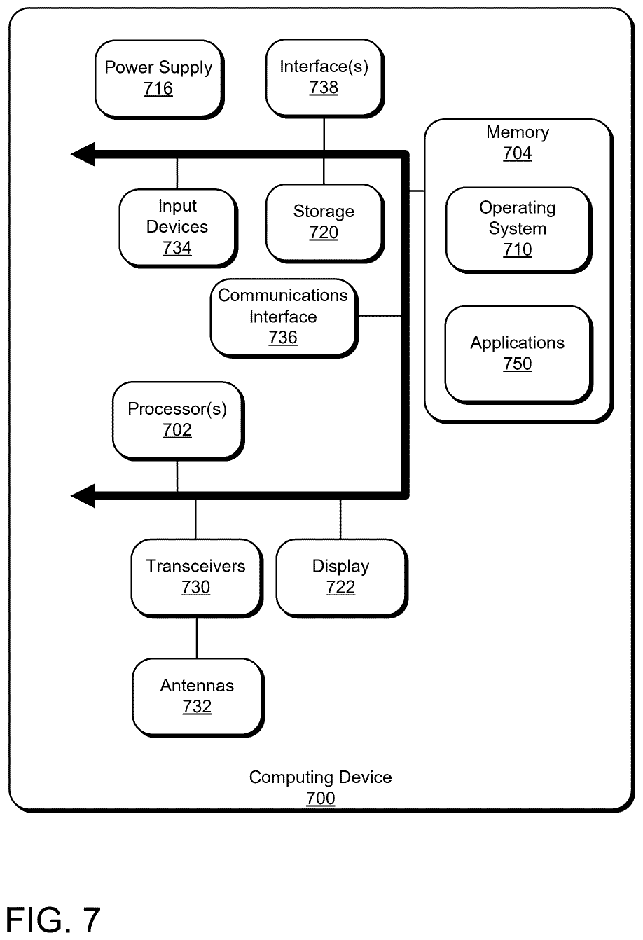

FIG. 7 illustrates an example computing device 700 for implementing the described technology. The computing device 700 may be a client computing device (such as a laptop computer, a desktop computer, or a tablet computer), a server/cloud computing device, an Internet-of-Things (IoT), any other type of computing device, or a combination of these options. The computing device 700 includes one or more hardware processor(s) 702 and a memory 704. The memory 704 generally includes both volatile memory (e.g., RAM) and nonvolatile memory (e.g., flash memory), although one or the other type of memory may be omitted. An operating system 710 resides in the memory 704 and is executed by the processor(s) 702. In some implementations, the computing device 700 includes and/or is communicatively coupled to storage 720.

In the example computing device 700, as shown in FIG. 7, one or more software modules, segments, and/or processors, such as an anomaly investigation system, a domain selector, a hypothesis tree generator, an MLM finetuner, a signal preprocessor, a correlation identifier, a candidate root causes identifier, a hypothesis selector, a hypothesis investigator, applications 750, and other program code and modules are loaded into the operating system 710 on the memory 704 and/or the storage 720 and executed by the processor(s) 702. The storage 720 may store data (e.g., including one or more multi-modal signals, domain-specific tools, domain-specific MLMs, domain-specific hypothesis trees, preprocessed multi-modal signals, inferences, inferences queries, possible root causes queries, candidate root causes, hypotheses, hypothesis queries, responses, root causes, features of interest, correlations, and other data) and be local to the computing device 700 or may be remote and communicatively connected to the computing device 700. In particular, in one implementation, components of a system for determining root causes explaining one or more features of a multi-modal signal using a domain-specific MLM may be implemented entirely in hardware or in a combination of hardware circuitry and software.

The computing device 700 includes a power supply 716, which may include or be connected to one or more batteries or other power sources and which provides power to other components of the computing device 700. The power supply 716 may also be connected to an external power source that overrides or recharges the built-in batteries or other power sources.

The computing device 700 may include one or more communication transceivers 730, which may be connected to one or more antenna(s) 732 to provide network connectivity (e.g., mobile phone network, Wi-Fi®, Bluetooth®) to one or more other servers, client devices, IoT devices, and other computing and communications devices. The computing device 700 may further include a communications interface 736 (such as a network adapter or an I/O port, which are types of communication devices). The computing device 700 may use the adapter and any other types of communication devices for establishing connections over a wide-area network (WAN) or local-area network (LAN). It should be appreciated that the network connections shown are exemplary and that other communications devices and means for establishing a communications link between the computing device 700 and other devices may be used.

The computing device 700 may include one or more input devices 734 such that a user may enter commands and information (e.g., a keyboard, trackpad, or mouse). These and other input devices may be coupled to the server by one or more interfaces 738, such as a serial port interface, parallel port, or universal serial bus (USB). The computing device 700 may further include a display 722, such as a touchscreen display.

The computing device 700 may include a variety of tangible processor-readable storage media and intangible processor-readable communication signals. Tangible processor-readable storage can be embodied by any available media that can be accessed by the computing device 700 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 700. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.
Clause 1. A computer-implemented method of investigating anomalies in multi-modal data signals, the computer-implemented method comprising: receiving, using a domain-specific agent, a multi-modal data signal associated with a reported performance issue; instructing, using the domain-specific agent, a domain-specific multi-modal language model to identify a possible root cause for the reported performance issue by comparing the multi-modal data signal to a historical anomaly dataset and identifying a historical similar multi-modal signal and a corresponding root cause for the historical similar multi-modal signal, the domain-specific multi-modal language model being trained on the historical anomaly dataset that includes historically-observed multi-modal data signals corresponding to reported performance issues and corresponding steps carried out to investigate the reported performance issues and further documenting root causes responsible for the reported performance issue; retrieving, using the domain-specific agent, from a pre-populated hypothesis tree, a hypothesis that identifies the possible root cause and sets forth a series of operations for testing whether the possible root cause is linked to the reported performance issue; instructing, using the domain-specific agent, the domain-specific multi-modal language model to execute the series of operations for testing the hypothesis; and in response to receiving an output from the domain-specific multi-modal language model identifying the hypothesis as true, generating and returning, using the domain-specific agent, an output that identifies the possible root cause as a source of the reported performance issue.
Clause 2. The computer-implemented method of clause 1, wherein the pre-populated hypothesis tree includes one or more candidate root causes, a set of inference instructions for communicating with the domain-specific multi-modal language model to obtain relevant information from one or more components of the multi-modal data signal for testing each of the one or more candidate root causes including the possible root cause.
Clause 3. The computer-implemented method of clause 1, further comprising: generating, using the domain-specific multi-modal language model, a plurality of pre-populated hypothesis trees corresponding to each of a plurality of root causes including the possible root cause based on the historical anomaly dataset.
Clause 4. The computer-implemented method of clause 1, wherein the historical anomaly dataset includes analyses of the historically-observed multi-modal data signals, the analyses including reasoning steps for verifying the possible root cause.
Clause 5. The computer-implemented method of clause 1, further comprising: identifying a knowledge domain for the multi-modal data signal, the identified knowledge domain being a knowledge domain corresponding to the domain-specific agent; and transmitting the multi-modal data signal to the domain-specific agent responsive to identifying the knowledge domain.
Clause 6. The computer-implemented method of clause 1, further comprising normalizing one or more component features of a raw multi-modal data signal to yield the multi-modal data signal.
Clause 7. The computer-implemented method of clause 1, further comprising: generating the pre-populated hypothesis tree based on the historical anomaly dataset, wherein generating the pre-populated hypothesis tree includes extracting annotated sets of inference instructions corresponding to the possible root cause from the historical anomaly dataset.
Clause 8. One or more tangible processor-readable storage media embodied with instructions for executing on one or more processors and circuits of a computing device a process for investigating anomalies in multi-modal data signals, the process comprising: receiving, using a domain-specific agent, a multi-modal data signal associated with a reported performance issue; instructing, using the domain-specific agent, a domain-specific multi-modal language model to identify a possible root cause for the reported performance issue by comparing the multi-modal data signal to a historical anomaly dataset and identifying a historical similar multi-modal signal and a corresponding root cause for the historical similar multi-modal signal, the domain-specific multi-modal language model being trained on the historical anomaly dataset that includes historically-observed multi-modal data signals corresponding to reported performance issues and corresponding steps carried out to investigate the reported performance issues and further documenting root causes responsible for the reported performance issue; retrieving, using the domain-specific agent, from a pre-populated hypothesis tree, a hypothesis that identifies the possible root cause and sets forth a series of operations for testing whether the possible root cause is linked to the reported performance issue; instructing, using the domain-specific agent, the domain-specific multi-modal language model to execute the series of operations for testing the hypothesis; and in response to receiving an output from the domain-specific multi-modal language model identifying the hypothesis as true, generating and returning, using the domain-specific agent, an output that identifies the possible root cause as a source of the reported performance issue.
Clause 9. The one or more tangible processor-readable storage media of clause 8, wherein the pre-populated hypothesis tree includes one or more candidate root causes, a set of inference instructions for communicating with the domain-specific multi-modal language model to obtain relevant information from one or more components of the multi-modal data signal for testing each of the one or more candidate root causes including the possible root cause.
Clause 10. The one or more tangible processor-readable storage media of clause 8, the process further comprising generating, using the domain-specific multi-modal language model, a hypothesis tree corresponding to each of a plurality of root causes including the possible root cause based on the historical anomaly dataset.
Clause 11. The one or more tangible processor-readable storage media of clause 8, wherein the historical anomaly dataset includes analyses of the historically-observed multi-modal data signals, the analyses including reasoning steps for verifying the possible root cause.
Clause 12. The one or more tangible processor-readable storage media of clause 8, the process further comprising: identifying a knowledge domain for the multi-modal data signal, the identified knowledge domain being a knowledge domain corresponding to the domain-specific agent; and transmitting the multi-modal data signal to the domain-specific agent responsive to identifying the knowledge domain.
Clause 13. The one or more tangible processor-readable storage media of clause 8, the process further comprising normalizing one or more component features of a raw multi-modal data signal to yield the multi-modal data signal.
Clause 14. A computing system for investigating features of interest in multi-modal data signals, the computing system comprising: one or more hardware processors; a domain-specific multi-modal language model stored in memory and trained on a domain-specific historical anomaly dataset corresponding to a knowledge domain including historically-observed multi-modal data signals including features of interest and corresponding steps carried out to investigate the features of interest and further documenting root causes responsible for the features of interest; and a domain-specific agent stored in the memory and executable by the one or more hardware processors and configured to: receive a multi-modal data signal including a feature of interest; instruct the domain-specific multi-modal language model to identify a candidate root cause for the feature of interest by comparing the multi-modal data signal to the domain-specific historical anomaly dataset and identify a historical similar multi-modal signal and a corresponding root cause for the historical similar multi-modal signal; retrieve, from a pre-populated hypothesis tree, a hypothesis corresponding to the candidate root cause, the hypothesis setting forth a series of operations for testing whether the candidate root cause is linked to the feature of interest; instruct the domain-specific multi-modal language model to execute the series of operations for testing the hypothesis; and in response to receiving an output from the domain-specific multi-modal language model identifying the hypothesis as true, generate and return an output that identifies the candidate root cause as a source of the feature of interest.
Clause 15. The computing system of clause 14, wherein the pre-populated hypothesis tree includes one or more candidate root causes, a set of inference instructions for communicating with the domain-specific multi-modal language model to obtain relevant information from one or more components of the multi-modal data signal for testing each of the one or more candidate root causes including the candidate root cause.
Clause 16. The computing system of clause 15, further comprising a hypothesis tree generator stored in the memory and executable by the one or more hardware processors and configured to generate, using the domain-specific multi-modal language model, the pre-populated hypothesis tree corresponding to each of the one or more candidate root causes by including the set of inference instructions in association with the one or more candidate root causes.
Clause 17. The computing system of clause 14, wherein the domain-specific historical anomaly dataset includes analyses of the features of interest of the historically-observed multi-modal data signals, the analyses including reasoning steps for verifying the candidate root cause.
Clause 18. The computing system of clause 14, further comprising a domain selector stored in the memory and executable by the one or more hardware processors and configured to: identifying a knowledge domain for the multi-modal data signal, the identified knowledge domain being a knowledge domain corresponding to the domain-specific agent; and transmitting the multi-modal data signal to the domain-specific agent responsive to identifying the knowledge domain.
Clause 19. The computing system of clause 14, wherein the domain-specific agent further comprises a signal preprocessor stored in the memory and executable by the one or more hardware processors and configured to normalize one or more component features of a raw multi-modal data signal to yield the multi-modal data signal.
Clause 20. The computing system of clause 14, further comprising a hypothesis tree generator stored in the memory and executable by the one or more hardware processors and configured to generate the pre-populated hypothesis tree based on the domain-specific historical anomaly dataset, wherein generating the pre-populated hypothesis tree includes extracting annotated sets of inference instructions corresponding to one or more candidate root causes from the domain-specific historical anomaly dataset.
Clause 21. A system of investigating anomalies in multi-modal data signals, the computer-implemented method comprising: means for receiving, using a domain-specific agent, a multi-modal data signal associated with a reported performance issue; means for instructing, using the domain-specific agent, a domain-specific multi-modal language model to identify a possible root cause for the reported performance issue by comparing the multi-modal data signal to a historical anomaly dataset and identifying a historical similar multi-modal signal and a corresponding root cause for the historical similar multi-modal signal, the domain-specific multi-modal language model being trained on the historical anomaly dataset that includes historically-observed multi-modal data signals corresponding to reported performance issues and corresponding steps carried out to investigate the reported performance issues and further documenting root causes responsible for the reported performance issue; means for retrieving, using the domain-specific agent, from a pre-populated hypothesis tree, a hypothesis that identifies the possible root cause and sets forth a series of operations for testing whether the possible root cause is linked to the reported performance issue; means for instructing, using the domain-specific agent, the domain-specific multi-modal language model to execute the series of operations for testing the hypothesis; and means for generating and returning, in response to receiving an output from the domain-specific multi-modal language model identifying the hypothesis as true, using the domain-specific agent, an output that identifies the possible root cause as a source of the reported performance issue.
Clause 22. The system of clause 21, wherein the pre-populated hypothesis tree includes one or more candidate root causes, a set of inference instructions for communicating with the domain-specific multi-modal language model to obtain relevant information from one or more components of the multi-modal data signal for testing each of the one or more candidate root causes including the possible root cause.
Clause 23. The system of clause 21, further comprising: means for generating, using the domain-specific multi-modal language model, a plurality of pre-populated hypothesis trees corresponding to each of a plurality of root causes including the possible root cause based on the historical anomaly dataset.
Clause 24. The system of clause 21, wherein the historical anomaly dataset includes analyses of the historically-observed multi-modal data signals, the analyses including reasoning steps for verifying the possible root cause.
Clause 25. The system of clause 21, further comprising: means for identifying a knowledge domain for the multi-modal data signal, the identified knowledge domain being a knowledge domain corresponding to the domain-specific agent; and means for transmitting the multi-modal data signal to the domain-specific agent responsive to identifying the knowledge domain.
Clause 26. The computer-implemented method of clause 1, further comprising means for normalizing one or more component features of a raw multi-modal data signal to yield the multi-modal data signal.
Clause 27. The computer-implemented method of clause 1, further comprising: means for generating the pre-populated hypothesis tree based on the historical anomaly dataset, wherein generating the pre-populated hypothesis tree includes extracting annotated sets of inference instructions corresponding to the possible root cause from the historical anomaly dataset.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A computer-implemented method of investigating anomalies in multi-modal data signals, the computer-implemented method comprising:
receiving, using a domain-specific agent, a multi-modal data signal associated with a reported performance issue;
instructing, using the domain-specific agent, a domain-specific multi-modal language model to identify a possible root cause for the reported performance issue by comparing the multi-modal data signal to a historical anomaly dataset and identifying a historical similar multi-modal signal and a corresponding root cause for the historical similar multi-modal signal, the domain-specific multi-modal language model being trained on the historical anomaly dataset that includes historically-observed multi-modal data signals corresponding to reported performance issues and corresponding steps carried out to investigate the reported performance issues and further documenting root causes responsible for the reported performance issue;
retrieving, using the domain-specific agent, from a pre-populated hypothesis tree, a hypothesis that identifies the possible root cause and sets forth a series of operations for testing whether the possible root cause is linked to the reported performance issue;
instructing, using the domain-specific agent, the domain-specific multi-modal language model to execute the series of operations for testing the hypothesis; and
in response to receiving an output from the domain-specific multi-modal language model identifying the hypothesis as true, generating and returning, using the domain-specific agent, an output that identifies the possible root cause as a source of the reported performance issue.

2. The computer-implemented method of claim 1, wherein the pre-populated hypothesis tree includes one or more candidate root causes, a set of inference instructions for communicating with the domain-specific multi-modal language model to obtain relevant information from one or more components of the multi-modal data signal for testing each of the one or more candidate root causes including the possible root cause.

3. The computer-implemented method of claim 1, further comprising:
generating, using the domain-specific multi-modal language model, a plurality of pre-populated hypothesis trees corresponding to each of a plurality of root causes including the possible root cause based on the historical anomaly dataset.

4. The computer-implemented method of claim 1, wherein the historical anomaly dataset includes analyses of the historically-observed multi-modal data signals, the analyses including reasoning steps for verifying the possible root cause.

5. The computer-implemented method of claim 1, further comprising:
identifying a knowledge domain for the multi-modal data signal, the identified knowledge domain being a knowledge domain corresponding to the domain-specific agent; and
transmitting the multi-modal data signal to the domain-specific agent responsive to identifying the knowledge domain.

6. The computer-implemented method of claim 1, further comprising normalizing one or more component features of a raw multi-modal data signal to yield the multi-modal data signal.

7. The computer-implemented method of claim 1, further comprising:
generating the pre-populated hypothesis tree based on the historical anomaly dataset, wherein generating the pre-populated hypothesis tree includes extracting annotated sets of inference instructions corresponding to the possible root cause from the historical anomaly dataset.

8. One or more tangible processor-readable storage media embodied with instructions for executing on one or more processors and circuits of a computing device a process for investigating anomalies in multi-modal data signals, the process comprising:
receiving, using a domain-specific agent, a multi-modal data signal associated with a reported performance issue;
instructing, using the domain-specific agent, a domain-specific multi-modal language model to identify a possible root cause for the reported performance issue by comparing the multi-modal data signal to a historical anomaly dataset and identifying a historical similar multi-modal signal and a corresponding root cause for the historical similar multi-modal signal, the domain-specific multi-modal language model being trained on the historical anomaly dataset that includes historically-observed multi-modal data signals corresponding to reported performance issues and corresponding steps carried out to investigate the reported performance issues and further documenting root causes responsible for the reported performance issue;
retrieving, using the domain-specific agent, from a pre-populated hypothesis tree, a hypothesis that identifies the possible root cause and sets forth a series of operations for testing whether the possible root cause is linked to the reported performance issue;
instructing, using the domain-specific agent, the domain-specific multi-modal language model to execute the series of operations for testing the hypothesis; and
in response to receiving an output from the domain-specific multi-modal language model identifying the hypothesis as true, generating and returning, using the domain-specific agent, an output that identifies the possible root cause as a source of the reported performance issue.

9. The one or more tangible processor-readable storage media of claim 8, wherein the pre-populated hypothesis tree includes one or more candidate root causes, a set of inference instructions for communicating with the domain-specific multi-modal language model to obtain relevant information from one or more components of the multi-modal data signal for testing each of the one or more candidate root causes including the possible root cause.

10. The one or more tangible processor-readable storage media of claim 8, the process further comprising generating, using the domain-specific multi-modal language model, a hypothesis tree corresponding to each of a plurality of root causes including the possible root cause based on the historical anomaly dataset.

11. The one or more tangible processor-readable storage media of claim 8, wherein the historical anomaly dataset includes analyses of the historically-observed multi-modal data signals, the analyses including reasoning steps for verifying the possible root cause.

12. The one or more tangible processor-readable storage media of claim 8, the process further comprising:
identifying a knowledge domain for the multi-modal data signal, the identified knowledge domain being a knowledge domain corresponding to the domain-specific agent; and
transmitting the multi-modal data signal to the domain-specific agent responsive to identifying the knowledge domain.

13. The one or more tangible processor-readable storage media of claim 8, the process further comprising normalizing one or more component features of a raw multi-modal data signal to yield the multi-modal data signal.

14. A computing system for investigating features of interest in multi-modal data signals, the computing system comprising:
one or more hardware processors;
a domain-specific multi-modal language model stored in memory and trained on a domain-specific historical anomaly dataset corresponding to a knowledge domain including historically-observed multi-modal data signals including features of interest and corresponding steps carried out to investigate the features of interest and further documenting root causes responsible for the features of interest; and
a domain-specific agent stored in the memory and executable by the one or more hardware processors and configured to:
receive a multi-modal data signal including a feature of interest;
instruct the domain-specific multi-modal language model to identify a candidate root cause for the feature of interest by comparing the multi-modal data signal to the domain-specific historical anomaly dataset and identify a historical similar multi-modal signal and a corresponding root cause for the historical similar multi-modal signal;
retrieve, from a pre-populated hypothesis tree, a hypothesis corresponding to the candidate root cause, the hypothesis setting forth a series of operations for testing whether the candidate root cause is linked to the feature of interest;
instruct the domain-specific multi-modal language model to execute the series of operations for testing the hypothesis; and
in response to receiving an output from the domain-specific multi-modal language model identifying the hypothesis as true, generate and return an output that identifies the candidate root cause as a source of the feature of interest.

15. The computing system of claim 14, wherein the pre-populated hypothesis tree includes one or more candidate root causes, a set of inference instructions for communicating with the domain-specific multi-modal language model to obtain relevant information from one or more components of the multi-modal data signal for testing each of the one or more candidate root causes including the candidate root cause.

16. The computing system of claim 15, further comprising a hypothesis tree generator stored in the memory and executable by the one or more hardware processors and configured to generate, using the domain-specific multi-modal language model, the pre-populated hypothesis tree corresponding to each of the one or more candidate root causes by including the set of inference instructions in association with the one or more candidate root causes.

17. The computing system of claim 14, wherein the domain-specific historical anomaly dataset includes analyses of the features of interest of the historically-observed multi-modal data signals, the analyses including reasoning steps for verifying the candidate root cause.

18. The computing system of claim 14, further comprising a domain selector stored in the memory and executable by the one or more hardware processors and configured to:
identifying a knowledge domain for the multi-modal data signal, the identified knowledge domain being a knowledge domain corresponding to the domain-specific agent; and
transmitting the multi-modal data signal to the domain-specific agent responsive to identifying the knowledge domain.

19. The computing system of claim 14, wherein the domain-specific agent further comprises a signal preprocessor stored in the memory and executable by the one or more hardware processors and configured to normalize one or more component features of a raw multi-modal data signal to yield the multi-modal data signal.

20. The computing system of claim 14, further comprising a hypothesis tree generator stored in the memory and executable by the one or more hardware processors and configured to generate the pre-populated hypothesis tree based on the domain-specific historical anomaly dataset, wherein generating the pre-populated hypothesis tree includes extracting annotated sets of inference instructions corresponding to one or more candidate root causes from the domain-specific historical anomaly dataset.
